(19) United States
(12) Patent Application Publication
(10) Pub. No.: US 2015/0019871 A1
(43) Pub. Date: Jan. 15, 2015

(54) CERTIFICATION METHOD AND ELECTRONIC DEVICE

(71) Applicant: Transcend Information, Inc., Taipei City (TW)

(72) Inventors: Shih-Chia HUANG, Taipei City (TW); Yu-Hsin LIN, Taipei City (TW)

(21) Appl. No.: 13/938,246

(22) Filed: Jul. 10, 2013

(51) Int. Cl. H04L 9/32

(52) U.S. Cl. CPC H04L 9/3247; H04L 9/3236; H04L 9/3239
USPC 713/176

(57) ABSTRACT

A certification method comprises steps of: providing a reliable time clock on a first electronic device; when data of the digital file are generated on the first electronic device, reading a reliable time count from the reliable time clock and adding the reliable time count into the digital file; generating a first abstract code from the digital file; generating a signature of the digital file by encrypting the first abstract code; and, sending the digital file and the signature to a second electronic device. In addition, electronic devices corresponding to the certification method are also disclosed herein.

### BACKGROUND

1. Field of Invention

The present application relates to certification/verification method between multiple devices. More particularly, the present application relates to certification/verification based on a time attached with a target file.

2. Description of Related Art

Network technologies are highly developed recently. Information can be broadcasted worldwide over the network without any limitation. Therefore, a sender device may easily transmit a digital file to a receiver device via email, ftp, message, P2P file transmission or any equivalent transmission manner.

Since the internet is open to all users around the world, the digital file sent to the target receiver may be intercepted by some others during the transmission. The interceptor may intentionally amend, rewrite or make up data in the digital file, such that the receiver may be misled by the amended file. The digital file may includes some sensitive contents (e.g., voice recording data, contracts, payment details, etc) related to important events, business secrets or some personal issues. The receiver will be exposed to unexpected risks if he does not notice the digital file has been amended.

Therefore, it is important to establish a certification/verification manner, such that the receiver may confirm whether the incoming file is the original file sent from the designated sender.

### SUMMARY

An aspect of the present disclosure is to provide a certification method for a digital file. The certification method comprises steps of: providing a reliable time dock on a first electronic device; generating data of a digital file with a reliable time read from the reliable time dock; generating a first abstract code from the digital file; generating a signature of the digital file by encrypting the first abstract code; and, sending the digital file and the signature to a second electronic device.

Another aspect of the present disclosure is to provide an electronic device, which comprises a reliable time clock, a processing module and a certification module. The reliable time clock is configured for providing a reliable time. The processing module is configured for generating data of a digital file with a reliable time read from the reliable time clock. The certification module is electrically connected with the reliable time dock and the processing module. The certification module is electrically connected with the reliable time dock and the processing module. The certification module is configured for generating an abstract code from the digital file comprising the reliable time and generating a signature of the digital file by encrypting the abstract code.

Another aspect of the present disclosure is to provide an electronic device, which comprises a processing module and a verification module. The processing module is configured for receiving a digital file and a signature corresponding to the digital file from another electronic device. The verification module is electrically connected with the processing module. The verification module comprises an abstracting unit, a decryption unit and a comparator unit. The abstracting unit is configured for generating a first abstract code from the digital file. The decryption unit is configured for obtaining a second abstract code by decrypting the signature. The comparator unit is configured for comparing the first abstract code and the second abstract code to verify the digital file.

### BRIEF DESCRIPTION OF THE DRAWINGS

The disclosure can be more fully understood by reading the following detailed description of the embodiments, with reference made to the accompanying drawings as follows:

FIG. 1A and FIG. 1B are flow charts illustrating a certification method according to an embodiment of the disclosure;

FIG. 2 is a schematic diagram illustrating operational procedures related to a digital file according to an embodiment of the disclosure; and

FIG. 3 is a functional block diagram illustrating two electronic devices suitable of performing the certification method according to an embodiment of the disclosure.

### DETAILED DESCRIPTION

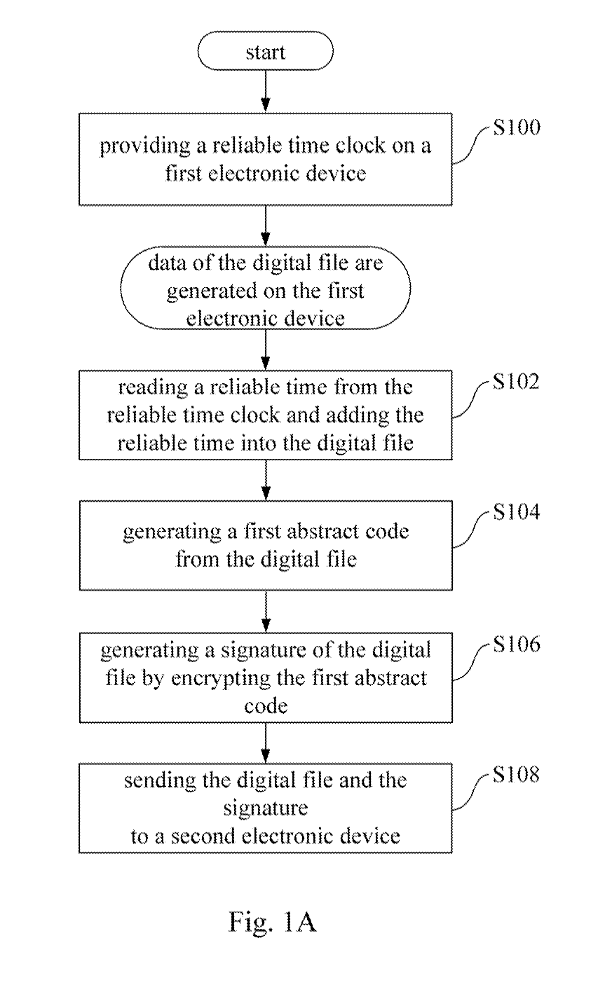

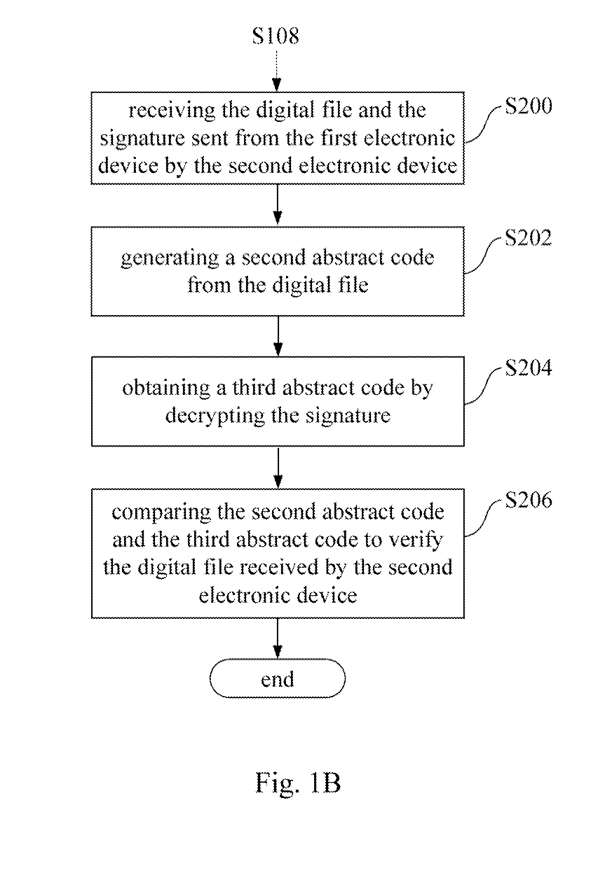

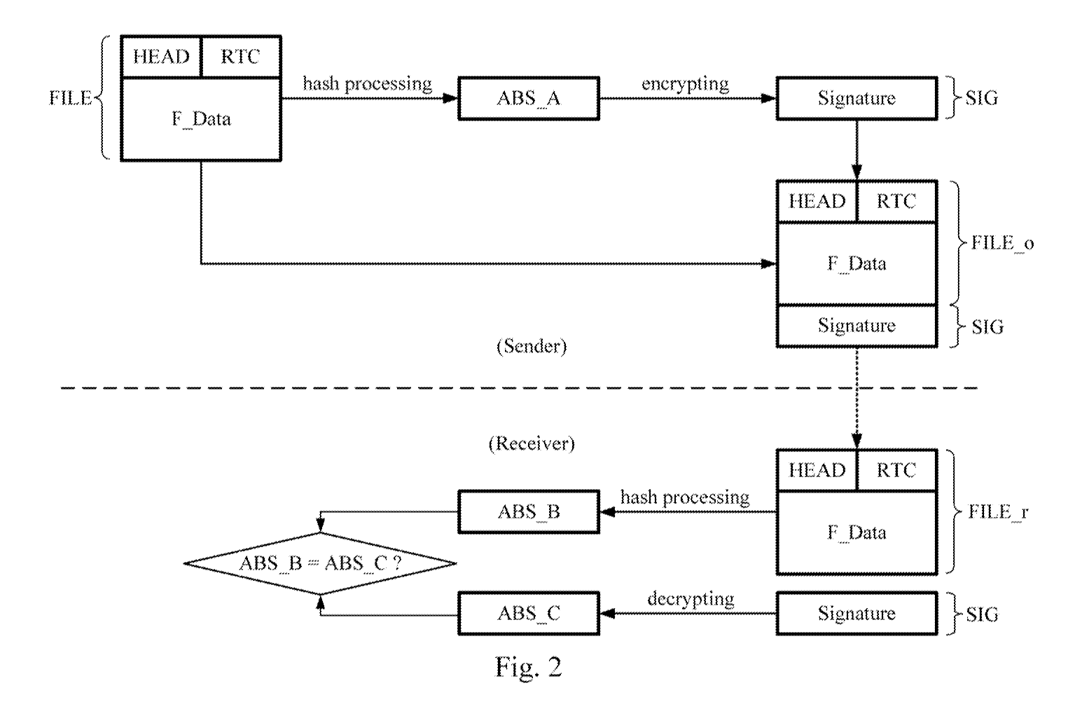

Reference is made to FIG. 1A, FIG. 1B and FIG. 2. FIG. 1A and FIG. 1B are flow charts illustrating a certification method according to an embodiment of the disclosure. FIG. 2 is a functional block diagram illustrating operational procedures related to a digital file according to an embodiment of the disclosure.

In the embodiment, the certification method shown in FIG. 1A and FIG. 1B is used to certify/verify a digital file transmitted from a first electronic device (i.e., the sender) to a second electronic device (i.e., the receiver). The first electronic device may perform steps, shown in FIG. 1A, corresponding to the sender. The second electronic device may perform steps, shown in FIG. 1B, corresponding to the receiver.

As shown in FIG. 1A and FIG. 2, step S100 of the certification method is executed for providing a reliable time clock on the first electronic device. The reliable time clock is configured for providing a reliable time. The reliable time clock can be an internal component built in the first electronic device, or a stand-alone component outside the first electronic device. If the reliable time clock is built in the first electronic device, the reliable time clock can be calibrated periodically to match a reference time server over internet/satellite; if the reliable time clock is stand alone, the reliable time generated by the reliable time clock can be transmitted to the first electronic device via wired or wireless communication. The further details about how to realize the reliable time clock will be disclosed in following paragraphs.

When data F_Data of the digital file are generated on the first device, step S102 of the certification method is executed for reading a reliable time RT from the reliable time clock and adding the reliable time RT into the digital file FILE_o. In other words, the data of the digital file is generated with a reliable time read from the reliable time clock. In some embodiments, the reliable time RT can be added into a header of the digital file FILE_o. The digital file can be an audio recording file, a video file, a document file, or any equivalent file (e.g., any digital file including a header column capable of recording the reliable time RT). In this embodiment, the digital file FILE_o is an audio file for example. After step S102, the digital file may include the data F_Data, original header information HEAD (e.g., ID3 tag), and the reliable time RT which can he added into the header column of the digital file FILE_o (as shown in FIG. 2).

The reliable time RT records the precise time (e.g., including information of year, date, minute, second, and even smaller time scale if necessary) representing when the data F_Data of the digital file are generated. Because time is irreversible, an identical time does not happen twice, such that the time may serve as an evidence for proving the originality of the digital file. The reliable time RT on the first electronic device is not manually modifiable (i.e., can not be revise/set/change by user manually). In practical applications, the reliable time RT on the first electronic device can be realized in several ways.

In an embodiment, when step S102 is executed to read the reliable time RT and the first electronic device is capable of establishing a network connection to the internet, the certification method further includes steps of accessing a reference time server (in this case, the reference time server can be a network time server) on the internet via the network connection, and synchronizing the reliable time clock with the reference time server.

In another embodiment, when step S102 is executed to read the reliable time RT and the first electronic device capable of launching a global positioning function, the certification method further includes steps of accessing a reference time server (in this case, the reference time server can be a reference clock on a satellite) based on the global positioning function, and synchronizing the reliable time clock with the reference time server.

In another embodiment, the first electronic device includes a battery. The reliable time clock is powered by the battery. The reliable time RT of the reliable time clock is synchronized to an official clock when the first electronic device is manufactured, and the reliable time RT is configured to be unmodifiable (e.g., by removing the time setting function in the firmware on the first electronic device).

Afterward, step S104 of the certification method is executed for generating a first abstract code ABS_A from the digital file FILE_o including the reliable time RT. In this embodiment, step S104 may generate the first abstract code ABS_A by the transformation of a hash algorithm. For example, the hash algorithm can be selected from MD5, SHA-1, SHA-256, SHA-384, SHA-512 or CRC32 algorithm. The hash algorithm is used to generate a unique symbol code from huge data. If the data inputs to the hash algorithm are the same, the outputs (i.e., the abstract code) will also be the same. Otherwise, if there is a slight difference between two data inputs to the hash algorithm, the outputs will be obviously different after the transformation of the hash algorithm.

Afterward, step S106 of the certification method is executed for generating a signature SIG of the digital file FILE_o by encrypting the first abstract code ABS_A. For example, the signature SIG can be generated by encrypting the first abstract code ABS_A based on a RSA encryption algorithm according to a private key owned by a user of the first electronic device.

Afterward, step S108 of the certification method is executed for sending the digital file FILE_o and the signature SIG to a second electronic device (i.e., the receiver). Accordingly, the second electronic device may have the ability to verify the digital file FILE_o by the signature SIG and the reliable time RT within the digital file FILE_o.

As shown in FIG. 1B and FIG. 2, the step S200 of the certification method is executed for receiving the digital file FILE_r and the signature SIG sent from the first electronic device by the second electronic device.

Afterward, step S202 of the certification method is executed for generating a second abstract code ABS_B from the digital file FILE_r.

It is noticed that, the first abstract code ABS_A (generated at step S104) and the second abstract code ABS_B (generated at step S202) are generated by an identical algorithm. In this embodiment, the first abstract code ABS_A and the second abstract code ABS_B must be processed by the same hash algorithm. In this case, if the digital file FILE_r received by the second electronic device is still the original digital file FILE_o (un-amended and not revised by another person) generated by the first electronic device, the first abstract code ABS_A and the second abstract code ABS_B will be the same. If the digital file FILE_r received by the second electronic device is not the original digital file the first abstract code ABS_A and the second abstract code ABS_B will be different, because the reliable time RT and/or the data DATA in the digital file FILE_r will not be the same as the reliable time RT and/or the data DATA in the digital file FILE_o.

Afterward, step S204 of the certification method is executed for obtaining a third abstract code ABS_C by decrypting the signature SIG. In this embodiment, the third abstract code ABS_C can be obtained by decrypting the signature SIG based on the RSA encryption algorithm according to a public key owned by the user of the first electronic device.

The public key corresponding to aforesaid private key is open to everyone and can be fetched from the internet. Therefore, the second electronic device may obtain the public key corresponding to the private key of the first electronic device, such that the second electronic device may decrypt the signature SIG. However, the second electronic device can not obtain the private key of the first device. Therefore, the second electronic device may not re-produce the signature SIG certified by the first electronic device. In this case, the third abstract code ABS_C decrypted from the signature SIG is the same as the first abstract code ABS_A.

Afterward, step S206 of the certification method is executed for comparing the second abstract code ABS_B and the third abstract code ABS_C to verify the digital file received by the second electronic device. If the second abstract code ABS_B and the third abstract code ABS_C are the same, the second electronic device may verify that the digital file FILE_r received by the second electronic device is still the original digital file FILE_o (un-amended and not revised by another person) generated by the first electronic device. If the second abstract code ABS_B and the third abstract code ABS_C are not the same, the second electronic device may notice and react to this situation (e.g., sending a report to the first electronic device, discarding the digital file FILE_r, or any other operations).

In this embodiment, both of the digital files FILE_o and FILE_r record the reliable time RT besides the data F_Data. Even if some other duplicates the same data F_Data and puts the duplicated data F_Data into another file FILE_d (not shown in figures), the receiver can realize that the file FILE_d is not the original digital file FILE_o generated on the first electronic device, because the columns of reliable time RT must be different between the file FILE_d and the original digital file FILE_o.

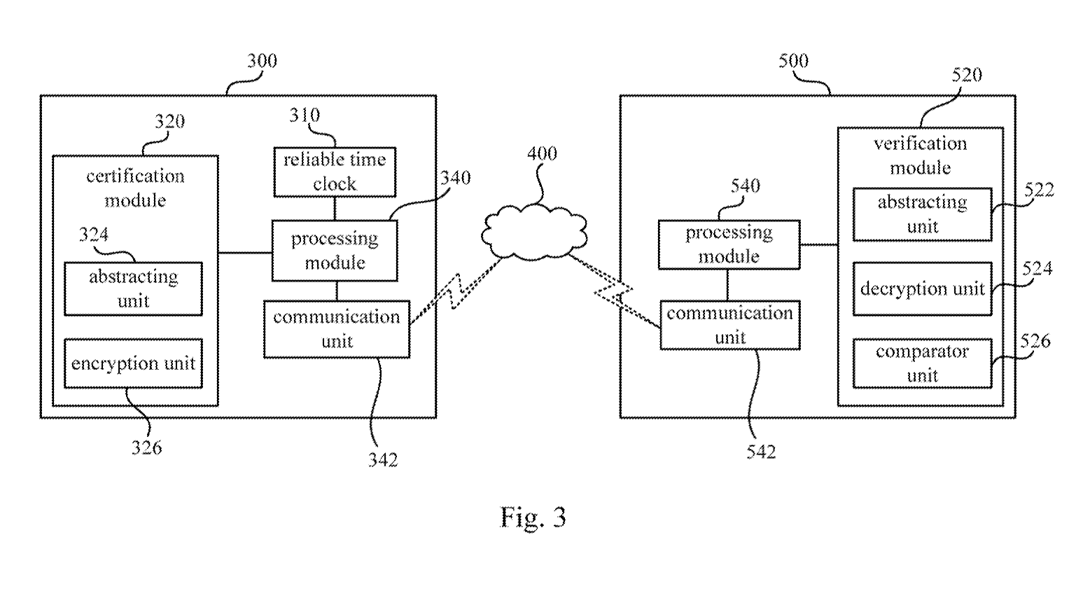

Reference is made to FIG. 3, which illustrates a file certification system between two electronic devices (the first electronic device 300 and the second electronic device 500) according to an embodiment of the disclosure. A digital file sent from the first electronic device 300 to the second electronic device 500 can be certificated based on the certification method in aforesaid embodiments.

As shown in FIG. 3, the first electronic device 300 (i.e., the sender in the embodiment) comprises a reliable time clock 310, a certification module 320 and a processing module 340. The reliable time clock 310 is configured for providing a reliable time. The processing module 340 is configured for generating data of the digital file. In this embodiment, when the digital file is generated, the processing module 340 is also configured for reading a reliable time from the reliable time clock, and the reliable time is added in (or attached to) the data of the digital file.

The first electronic device 300 may include a communication unit 342 for establishing a network connection to the internet 400. The certification module 320 is electrically connected with the reliable time clock 310 and the processing module 340. The certification module 320 comprises an abstracting unit 324 and an encryption unit 326.

The abstracting unit 324 is configured for generating an abstract code (by a hash algorithm, such as MD5, SHA-1, SHA-256, SHA-84, SHA-512 or CRC32) from the digital file including the added reliable time. The encryption unit 326 is configured for generating a signature of the digital file by encrypting the abstract code (according to a private key owned by a user of the first electronic device). The signature is sent along with the digital file to the second electronic device 500 over the internet 400.

The detail operations, including how to realize the reliable time clock 310 and the reliable time, on the first electronic device 300 are disclosed in aforesaid embodiments related to FIG. 1A and FIG. 2, and not to be repeated here again.

As shown in FIG. 3, the second electronic device 500 (i.e., the receiver in the embodiment) comprises a verification module 520 and a processing module 540. The second electronic device 500 includes a communication unit 542 for establishing a network connection to the internet 400. The processing module 540 is configured for receiving the digital file and the corresponding signature from the first electronic device 300. The verification module 520 is electrically connected with the processing module 540. The verification module 520 comprises an abstracting unit 522, a decryption unit 524 and a comparator unit 526. The abstracting unit 522 is configured for generating a second abstract code (by a hash algorithm, such as MD5, SHA-1, SHA-256, SHA-384, SHA-512 or CRC32) from the digital file. The decryption unit 524 is configured for obtaining a third abstract code by decrypting the signature (according to a public key corresponding to the private key). The comparator unit 526 is configured for comparing the second abstract code and the third abstract code to verify the digital file.

The detail operations on the second electronic device 500 are disclosed in aforesaid embodiments related to FIG. 1B and FIG. 2, and not to be repeated here again.

Based on aforesaid embodiments, this disclosure provides a certification method to certify/verify a digital file transmitted between different devices by a reliable time. The reliable time is configured to be unchangeable by users. Because time is irreversible, the identical time does not happen twice, such that the time may serve as an evidence for proving the originality of the digital file.

It will be apparent to those skilled in the art that various modifications and variations can be made to the structure of the present application without departing from the scope or spirit of the application. In view of the foregoing, it is intended that the present application cover modifications and variations of this application provided they fall within the scope of the following claims.

What is claimed is:

1. A certification method for a digital file, comprising:
providing a reliable time clock on a first electronic device;
generating data of a digital file with a reliable time read from the reliable time clock;
generating a first abstract code from the digital file;
generating a signature of the digital file by encrypting the first abstract code; and
sending the digital file and the signature to a second electronic device.

2. The certification method of claim 1, further comprising:
receiving the digital file and the signature sent from the first electronic device by the second electronic device;
generating a second abstract code from the digital file;
obtaining a third abstract code by decrypting the signature; and
comparing the second abstract code and the third abstract code to verify the digital file received by the second electronic device.

3. The certification method of claim 1, wherein the first abstract code and the second abstract code are generated by an identical algorithm.

4. The certification method of claim 1, wherein both of the first abstract code and the second abstract code are generated by a hash algorithm.

5. The certification method of claim 4, wherein the hash algorithm is selected from a group consisted of MD5, SHA-1, SHA-256, SHA-384, SHA-512 and CRC32.

6. The certification method of claim 1, wherein the first abstract code is encrypted according to a private key owned by a user of the first electronic device.

7. The certification method of claim 6, wherein the third abstract code is decrypted according to a public key corresponding to the private key owned by a user of the first electronic device.

8. The certification method of claim 1, wherein the first electronic device is capable of communicating with a reference time server, the certification method further comprising:
synchronizing the reliable clock on the electronic device with the reference time server.

9. The certification method of claim 8, wherein the reference time server is a satellite or a network time server.

10. The certification method of claim 1, wherein the first electronic device comprises a battery, the reliable time clock is powered by the battery, and the reliable time of the reliable time clock is synchronized to an official clock when the first electronic device is manufactured.

11. An electronic device, comprising:
a reliable time dock, configured for providing a reliable time;
a processing module, configured for generating data of a digital file with a reliable time read from the reliable time clock; and
a certification module, electrically connected with the reliable time clock and the processing module, configured for generating an abstract code from the digital file comprising the reliable time and generating a signature of the digital file by encrypting the abstract code.

12. The electronic device of claim 11, wherein the abstract code is generated by a hash algorithm.

13. The electronic device of claim 12, wherein the hash algorithm is selected from a group consisted of MD5, SHA-1, SHA-256, SHA-384, SHA-512 and CRC32.

14. The electronic device of claim 11, wherein the abstract code is encrypted according to a private key owned by a user of the electronic device.

15. The electronic device of claim 11, wherein the electronic device further comprises a communication unit for establishing a network connection to the internet, and the reliable time clock on the electronic device is synchronized with an official clock on the internet via the network connection.

16. The electronic device of claim 11, wherein the electronic device further comprises a global positioning unit for communicating with a satellite, the reliable time clock on the electronic device is synchronized with an official time read from the satellite.

17. The electronic device of claim 11, wherein the electronic device further comprises a battery powering the reliable time clock, and the reliable time count of the reliable time clock is synchronized to an official clock when the first electronic device is manufactured.

18. An electronic device, comprising:
a processing module, configured for receiving a digital file and a signature corresponding to the digital file from another electronic device; and
a verification module, electronically connected with the processing module, the verification module comprising:
an abstracting unit, configured for generating an first abstract code from the digital file;
a decryption unit, configured for obtaining a second abstract code by decrypting the signature; and
a comparator unit, configured for comparing the first abstract code and the second abstract code to verify the digital file.

19. The electronic device of claim 18, wherein the first abstract code is generated by a hash algorithm.

20. The electronic device of claim 19, wherein the hash algorithm is selected from a group consisted of MD5, SHA-1, SHA-256, SHA-384, SHA-512 and CRC32.
